(19) United States
(12) Patent Application Publication
(10) Pub. No.: US 2005/0231980 A1
(43) Pub. Date: Oct. 20, 2005

(54) EDGE-TYPE BACKLIGHT MODULE WITH A CURVED LAMP

(76) Inventors: Shoichi Ueda, Tokyo (JP); Bor-Jyh Pan, Miao-Li County (TW)

Correspondence Address: NORTH AMERICA INTELLECTUAL PROPERTY CORPORATION, P.O. BOX 506, MERRIFIELD, VA, 22116, US

(21) Appl. No.: 10/907,856

(22) Filed: Apr. 18, 2005

(30) Foreign Application Priority Data
Apr. 20, 2004 (TW) 093206075

(51) Int. Cl. G02F 1/1335

(52) U.S. Cl. 362/614

(57) ABSTRACT

An edge-type backlight module positioned under a display panel includes a light guide plate, a lampshade, and a lamp. The lamp including a curved part is installed inside the lampshade for emitting light to one side of the light guide plate.

### BACKGROUND OF INVENTION

1. Field of the Invention

The present invention relates to an edge-type backlight module, and more particularly, to an edge-type backlight module with a curved lamp.

2. Description of the Prior Art

Since liquid crystal itself cannot emit light, a backlight module can be taken as the key component of a liquid crystal display (LCD) panel, and the main function thereof is to provide a light source with sufficient brightness and uniform brightness distribution for the LCD panel to display images correctly. Since the LCD panel has been widely applied to various electrical products with growth potential such as a monitor, a notebook computer, a digital camera, a projector and so on, the demand for the backlight module and the related component is also growing.

Generally speaking, the backlight module are divided into two designs according to the position of the light source; one is the direct-type backlight module that the light source is disposed below the display panel, and the other is the edge-type backlight module that the light source is disposed on the edge side of the display panel. Since the edge-type backlight module is designed to have the light source disposed on the edge of the display panel, it may reduce the volume and the production cost of the liquid crystal display and can be applied to electrical products of small sizes.

Please refer to FIG. 1. A conventional edge-type backlight module 10 is disposed under the display panel 12. The edge-type backlight module 10 includes a light guide plate (LGP) 14 disposed below the display panel 12, a plurality of straight lamps 16 which can be cold cathode fluorescent lamps (CCFL) disposed on one side of the light guide plate 14, a lampshade 18 disposed outside the plurality of straight lamps 16, a reflecting sheet 20 disposed below the light guide plate 14 for reflecting the light emitted down through the light guide plate 14 back to the light guide plate 14, an optical layer 22 disposed between the light guide plate 14 and the display panel 12, and two lamp fixing support 24 disposed at two sides of the straight lamp 16 for fastening the straight lamp 16. The straight lamp 16 is used to provide a light source for the display panel 12, while the lampshade 18 and the reflecting sheet 20 are used to reflect the light generated by the straight lamp 16 to the light guide plate 14 for increasing the light efficiency and then providing a better output luminance. The micro scattering points below the light guide plate 14 can be used to destroy the total reflection of the light on the light guide plate 14 and then refract the light through the light guide plate 14 into the optical layer 22. The optical layer 22 is used to fog and concentrate the light refracted from the light guide plate 14 for the light source to provide more uniform brightness and wide front view angle to the display panel 12. Please refer to FIG. 2, which is the perspective view of the straight lamps emitting light to the light guide plate in a conventional edge-type backlight module 10. After the lampshade 18 wraps up the straight lamp 16 and is assembled with the lamp fixing support 24, the straight lamp 16 can provide a uniform light to one side of the light guide plate 14. The lampshade 18 and the reflecting sheet 20 are used to reflect the light generated by the straight lamp 16 to the light guide plate 14 for increasing the light utility rate and then provide a better output luminance.

Please refer to FIG. 3, which is the perspective view showing the wiring of the straight lamps 16 in the conventional edge-type backlight module 10. Each straight lamp 16 includes a high voltage electrode 26 and a low voltage electrode 28. The edge-type backlight module also includes an inverter 30 in order to transfer the alternating power source to the operating voltage needed by the straight lamps 16. The high voltage electrode 26 and the low voltage electrode 28 are electrically connected respectively through the high and low voltage conducting wire to the inverter 30, and then the inverter 30 generates a voltage difference that causes the discharging effect in order to drive the straight lamp 16 to emit light. The number of electrodes of the straight lamps 16 and the number of contact points with the conducting wire are twice the number of the straight lamp 16. The high voltage electrode 26 and the low voltage electrode 28 of the straight lamp 16 are disposed at the two ends thereof. When the current of the straight lamp 16 increases gradually, the straight lamp is lit up increasingly from the high voltage electrode 26 end to the low voltage electrode 28 end. As the direction of the arrowhead in the straight lamp 16 shown in FIG. 3, the straight lamp 16 is totally lit up at last.

The conventional edge-type backlight module 10 commonly uses many straight lamps 16 as the light source in order to meet the requirement of high luminance. But when the number of the straight lamps 16 increases, the number of electrodes of the straight lamps 16 and the number of the contact points with the conducting wire increase accordingly, then the wiring of the conducting wire will be more complicated and the possibility to have quality issues will be higher. Besides, the heat generated from the electrode end is the main heat source to the edge-type backlight module 10, and the exceeding high temperature of the straight lamp 16 will decrease the light efficiency of the lamp and then the power consumption needed for driving the straight lamp 16 will be raised accordingly. Besides the issues that the exceeding number of electrodes of the conventional edge-type backlight module generates more heat, the high voltage electrode 26 and the inverter 30 of the straight lamp 16 are usually disposed on the same side of the display panel so that heat is generated more easily and the temperature will get higher. Therefore the heat generated in operation will not be dissipated successfully but accumulate gradually, and cause the temperature to be not uniform at both side of the display panel 12. Once the operation time gets longer, it will not only effect the normal operation of the display panel 12 to decrease of the display quality but also reduce the lifetime of the components nearby substantially. In addition, since the high voltage electrode 26 and the low voltage electrode 28 of the straight lamp 16 are disposed at two ends of the straight lamp 16 and the straight lamp are made by the process of siphoning fluorescent powder so that the high voltage electrode 26 and the low voltage electrode 28 of the straight lamp 16 will have chromatic aberration and thereby the brightness at two ends of the display panel 12 is not uniform and the display quality is affected.

### SUMMARY OF INVENTION

The main objective of the invention is to provide an edge-type backlight module to solve the above-mentioned problems.

The claim of the invention is to provide an edge-type backlight module positioned under a display panel, the edge-type backlight module including a light guide plate, a lampshade, and a lamp. The lamp with a curved part is installed inside the lampshade for emitting light to the side edge of the light guide plate.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is the perspective view of the conventional edge-type backlight module.

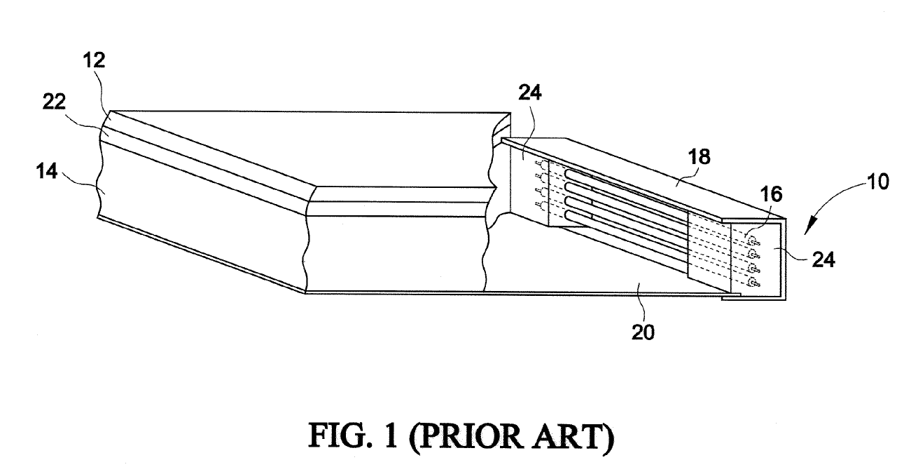

FIG. 2 is the schematic view of the straight lamp emitting light to the light guide plate in the conventional edge-type backlight module.

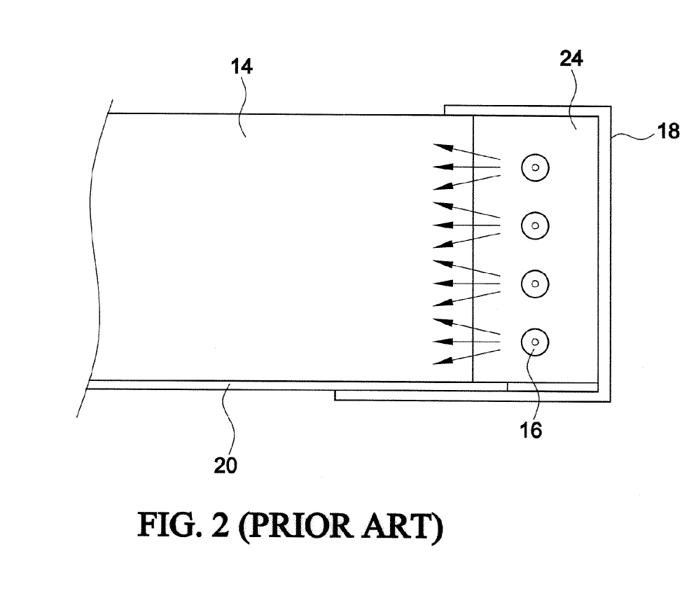

FIG. 3 is the perspective view showing the wiring of the straight lamp in the conventional edge-type backlight module.

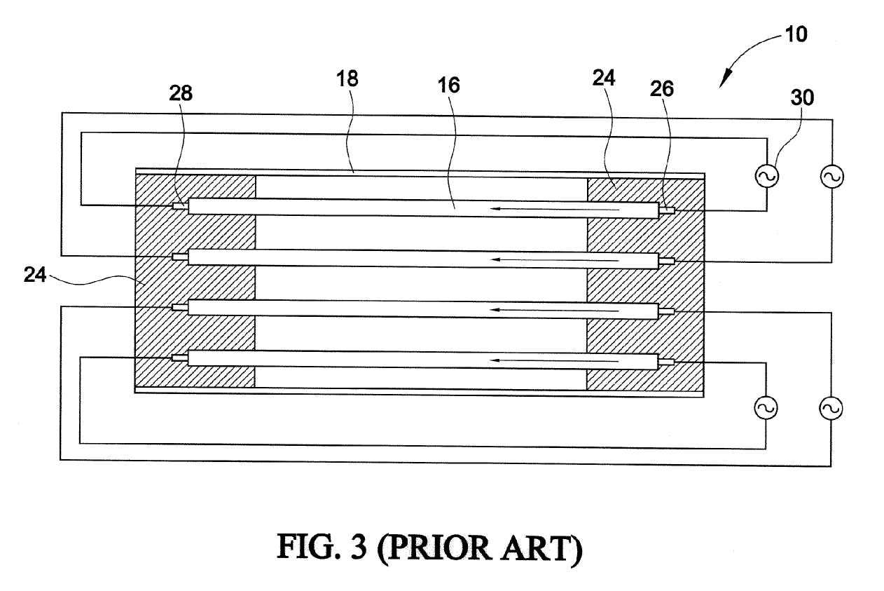

FIG. 4 is the functional block diagram of the computer apparatus in the present invention.

FIG. 5 is the perspective view of the edge-type backlight module in the first preferred embodiment of the present invention.

FIG. 6 is the perspective view of the U-type lamp that emits light to the light guide plate in the edge-type backlight module of the first preferred embodiment in the present invention.

FIG. 7 is the perspective view showing the wiring of the U-type lamp of the edgy-type backlight module.

FIG. 8 is the perspective view of the edge-type backlight module in the second preferred embodiment of the present invention.

FIG. 9 is the perspective view of the U-type lamp that emits light to the light guide plate of the edge-type backlight module in the second preferred embodiment of the present invention.

FIG. 10 is the perspective view of the edge-type backlight module that emits light to the light guide plate in the third preferred embodiment of the present invention.

FIG. 11 is the perspective view of the edge-type backlight module in the fourth preferred embodiment of the present invention.

FIG. 12 is the perspective view of the lamp that emits light to the light guide plate of the edge-type backlight module in the fourth preferred embodiment of the present invention.

### DETAILED DESCRIPTION

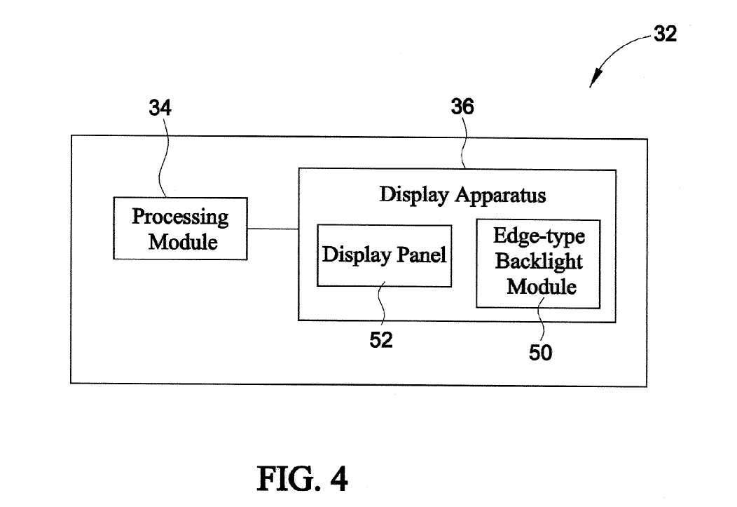

Please refer to FIG. 4. The computer apparatus 32 is a notebook and includes a processing module 34 for controlling the operation of the computer apparatus 32 and a display apparatus 36 electrically connected to the processing module 34 for displaying images transferred from the data from the processing module 34. The display apparatus 36 includes a display panel 52 and an edge-type backlight module 50.

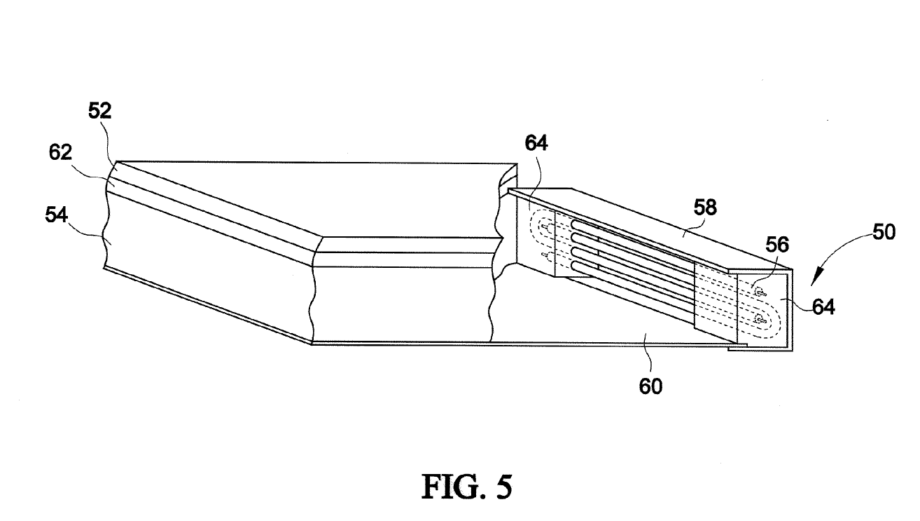

As shown in FIG. 5, the edge-type backlight module 50 is disposed below the display panel 52. The edge-type backlight module 50 is mainly composed of a light guide plate 54 disposed below the display panel 52, a plurality of U-type lamps 56 disposed on one side of the light guide plate 54 that can be cold cathode fluorescent lamps, a lampshade 58 disposed outside of the U-type lamp 56, a reflecting sheet 60 disposed below the light guide plate 54, an optical layer 62 disposed between the light guide plate 54 and display panel 52, and two lamp fixing support 64 disposed at two ends of the U-type lamp 16 in order to fasten the U-type lamp 56. The U-type lamp 56 is used to provide a light source to the display panel 52, the lampshade 58 and the reflecting sheet 60 is disposed to reflect the light generated by the U-type lamp 56 back to the light guide plate 54 in order to increase the light utility rate and then provide a better output luminance. The light guide plate 54 is used to scatter light generated from the U-type lamp 56 to the optical layer 62. The optical layer 62 is used to fog and concentrate the light from the light guide plate 54 in order to provide uniform light and wide front view angle for the display panel 52.

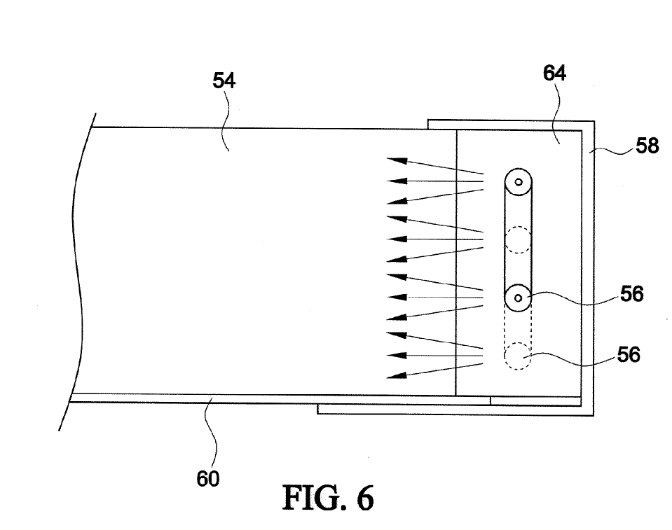

The light source of the edge-type backlight module 50 comes from the plurality of U-type lamps 56 disposed on one side of the light guide plate 54. In this embodiment, two U-type lamps 56 are staggered, that is, the openings of the two adjacent U-type lamp 56 face to two opposite ends of the display panel 52 respectively. The two openings of each U-type lamp 56 are disposed inside the same lamp fixing support 64, and the curved part of the U-type lamp 56 is covered by one of the lamp fixing support 64, therefore the part with poorer luminance and faster brightness decay is hidden inside the lamp fixing support 64. Please refer to FIG. 6. The lamp fixing support 64 covers the curved part and some of the straight part of the U-type lamp 56 and is then assembled with the lampshade 58, the U-type lamp 56 can provide an uniform light to one side of the light guide plate, while the lampshade 58 and the reflecting sheet 60 are used to reflect the light generated by the U-type lamp 56 to the light guide plate 54 in order to increase the light utility rate and then provide a better output luminance.

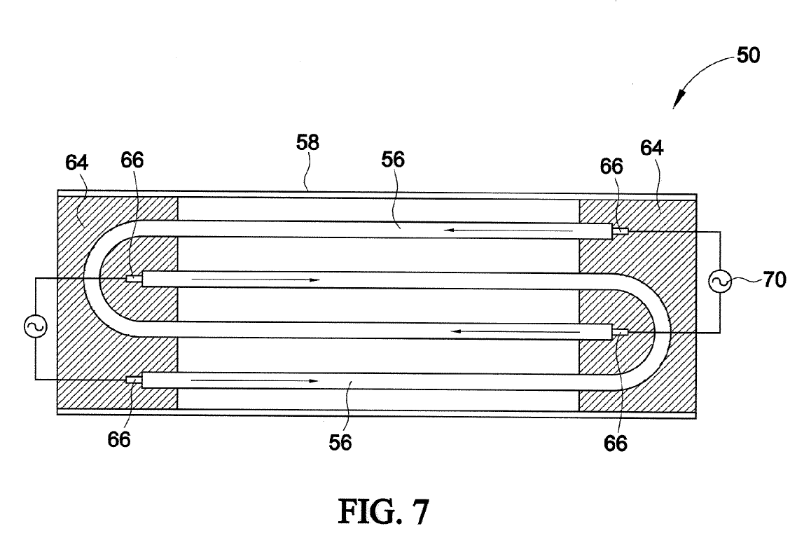

Please refer to FIG. 7. The two openings of each U-type lamp 56 are connected to two high voltage electrodes 66. The edge-type backlight module 50 includes an inverter 70 that is used to transfer the DC power supply into the working voltage need by the U-type lamp 56. The inverter 70 can be a floating-typing inverter that two high voltage electrodes 66 thereof are connected to the inverter 70 with conducting wires and for the U-type lamp 56 to emit light by the inverter 70. The inverter 70 can input simultaneously the alternating current that has phase difference to the two high voltage electrodes for driving the U-type lamp 56 to emit light. The luminance of the U-type lamp 56 according to the increase of the input current increases from the high voltage electrode 66 of the two openings gradually toward the curved part and eventually the whole lamp. As the direction of the arrowhead in the U-type lamp 56 shown in FIG. 7, the lamp is not lit up from one opening gradually to the other, and this can reduce the loading of the driving voltage. And the emitting area formed by the two staggered U-type lamps 56 is the same as that formed by four straight lamp, but the number of the electrodes and the connection points of the conduction wires of the U-type lamp 56 are half the number of that by using four straight lamps. The heat generated by the electrodes and the power consumption are both less then that by using four straight lamps, and the U-type lamp 56 can operate under an efficient working temperature and the emitting efficiency is higher accordingly. Besides the design without low voltage conducting wire in coordination with the design of the inverter 70, the simple wiring method can reduce the possibility of the instable quality followed by the complex wiring arrangement more efficiently. Moreover, since the two U-type lamps are staggered, the phenomenon that the chromatic aberration at two ends of the lamp because of the process of siphon fluorescent powder is improved, and the display panel gets more uniform hues distribution. In addition, the benefit from two staggered U-type lamps is that the high voltage electrodes 66 of the U-type lamp are disposed at two sides of the edge-type backlight module, and the separation of the high voltage electrodes 66 that easily generate heat can avoid the concentration of heat sources.

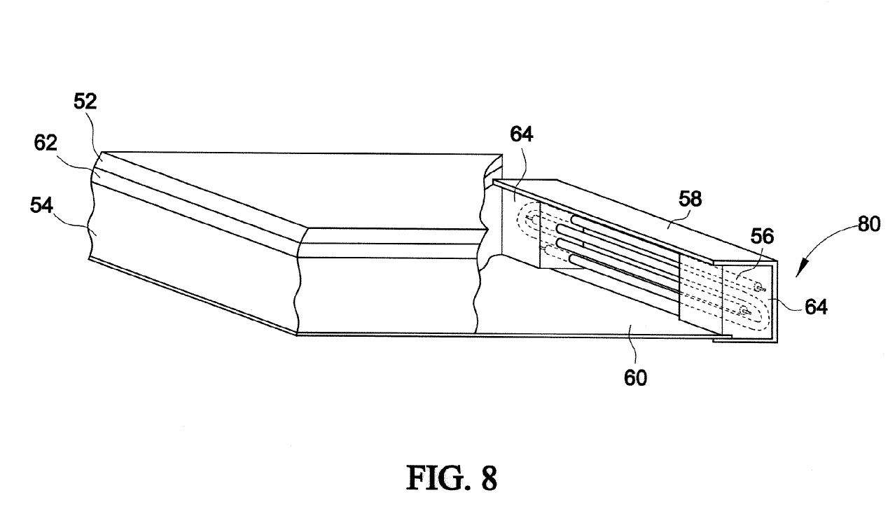

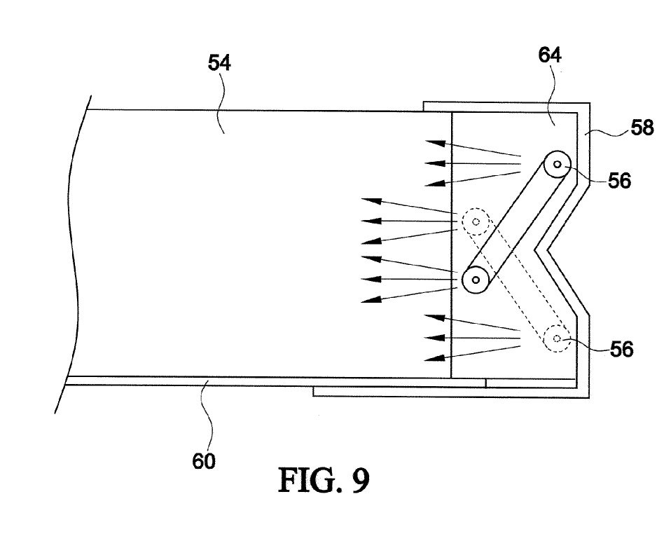

Please refer to FIG. 8 and FIG. 9. In the second preferred embodiment, the component structure and the operation of the edge-type backlight module 80 are similar to the edge-type backlight module 50 in the first preferred embodiment, and the edge-type backlight module 80 is disposed below the display panel 52. The edge-type backlight module comprises a light guide plate 54 disposed below the display panel 52, two U-type lamps disposed at one side of the light guide plate 54 which can be cold cathode fluorescent lamps, the lampshade 58 disposed outside of the two U-type lamps 56, a reflection sheet 60 disposed below the light guide plate, the optical layer 62 disposed between the light guide plate 54 and the display panel 52, and two fixing support 64 disposed at the two ends of the U-type lamp 56 in order to fasten the U-type lamp 56. The U-type lamp 56 is used to provide the light source for the display panel 52, the lampshade 58 and the reflecting sheet 60 is disposed to reflect light generated by the U-type lamp 56 back to the light guide plate 54 in order to increase the light utility rate and then provide a better output luminance. The light guide plate 54 is used to scatter the light generated from the U-type lamp 56 to the optical layer 62. The optical layer 62 is used to fog and concentrate the light from the light guide plate 54 in order to provide more uniform light and wide front view angle for the display panel 52. As shown in FIG. 9, the lamp fixing support 64 covers the curved part and some straight part of the U-type lamp 56 and is then assembled with the lampshade 58, the U-type lamp 56 can provide the uniform light source from one side of the light guide plate, while the lampshade 58 and the reflecting sheet 60 are used to reflect the light generated by the U-type lamp 56 to the light guide plate 54 in order to increase the light utility rate and then provide a better output luminance. However, the difference between the second and the first preferred embodiment is that the second preferred embodiment introduces two oblique staggered U-type lamp 56, and the emitting area formed by the two staggered U-type lamps 56 is the same as that formed by four straight lamp, but the number of the electrodes and the connection points of the conduction wires of the U-type lamp 56 are half the number of that by using four straight lamps. The heat generated by the electrodes and the power dissipation is both less then those by using four straight lamps. In addition, the method of two oblique staggered U-type lamp 56 can reduce the thickness of the lamp fixing support 64 and then lower the total height of the edge-type backlight module 80.

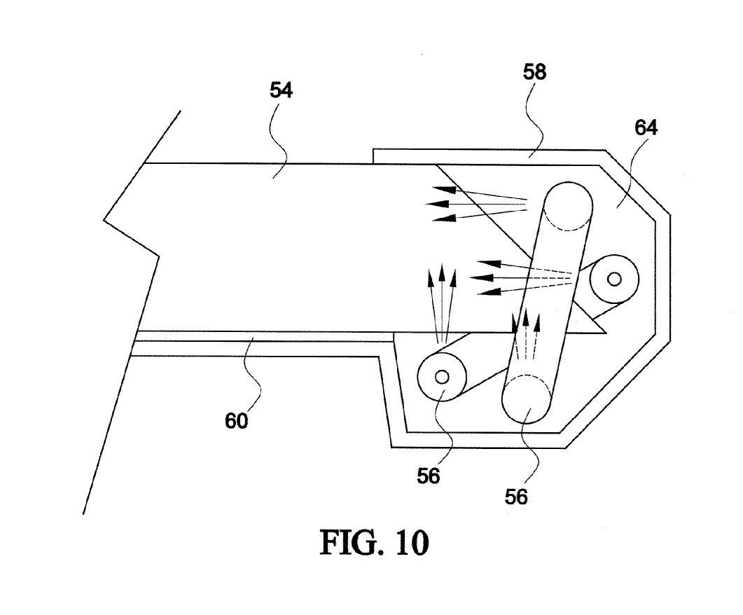

Please refer to FIG. 10. In the third embodiment, the component structure and operation of the edge-type backlight module 82 are similar to the edge-type backlight module 50 of the second preferred embodiment, the third preferred embodiment also introduces two oblique staggered U-type lamps 56 to act as the light source, and the emitting area formed by the two oblique staggered U-type lamps 56 is the same as that formed by four straight lamps, but the number of the electrodes and the connection points of the conduction wires are half the number of those by using four straight lamps. The heat generated by the electrodes and the power consumption is both less then those by using four straight lamps. The difference compared to the above preferred embodiment is that some part of the U-type lamp 56 is disposed at the edge of the light guide plate 54 and some part thereof is disposed below the light guide plate 54, and the U-type lamp 56 can provide uniform light from one side of the light guide plate 54. The U-type lamps 56 of this preferred embodiment wherein two oblique staggered U-type lamps 56 with some part thereof disposed below the light guide plate 54 can lower the total height of the edge-type backlight module 82.

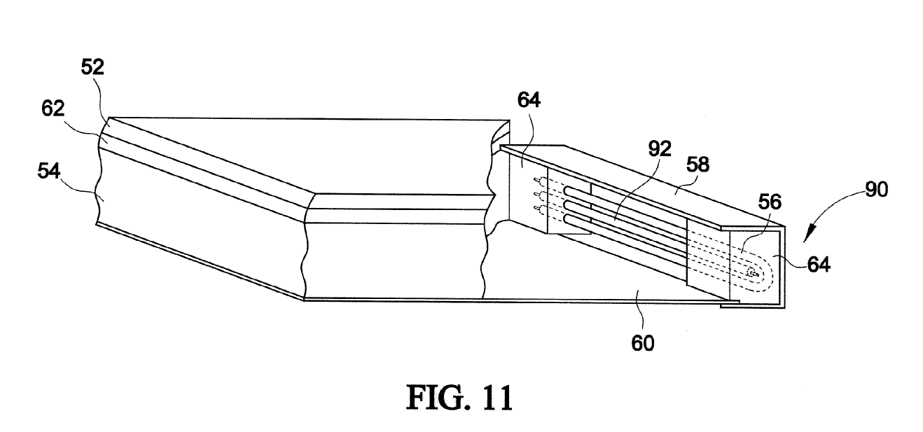

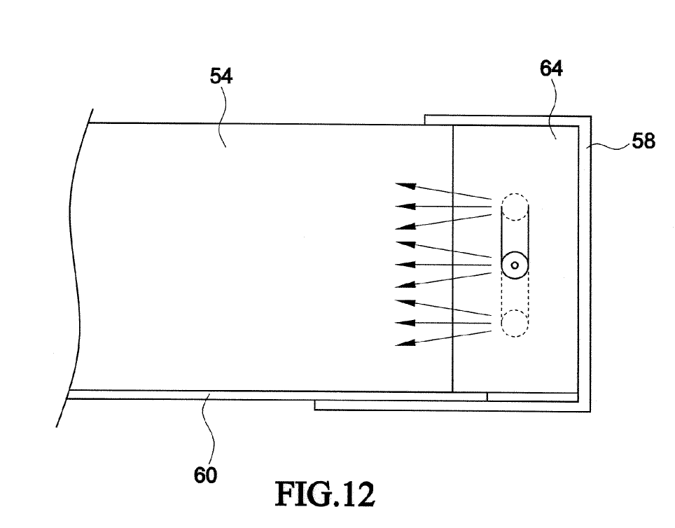

Please refer to FIG. 11 and FIG. 12. In the fourth preferred embodiment, the component structure and the operation of the edge-type backlight module 90 are also similar to the edge-type backlight module 50 of the first preferred embodiment, and the edge-type backlight module 90 is disposed below the display panel 52. The edge-type backlight module 90 comprises a light guide plate 54 disposed below the display panel 52, one U-type lamp disposed at one side of the light guide plate 54 which can be a cold cathode fluorescent lamp, a straight lamp 92 disposed between the two arms of the U-type lamp 56, the lampshade 58 disposed outside of the U-type lamp 56 and the straight lamp 92, a reflection sheet 60 disposed below the light guide plate 54, the optical layer 62 disposed between the light guide plate 54 and the display panel 52, and two fixing support 64 disposed at the two ends of the U-type lamp 56 in order to fasten the U-type lamp 56 and the straight lamp 92. The U-type lamp 56 and the straight lamp 92 are used to provide light to the display panel 52, the lampshade 58 and the reflecting sheet 60 are disposed to reflect the light generated by the U-type lamp 56 and the straight lamp 92 back to the light guide plate 54 in order to increase the light utility rate and then provide a better output luminance. The light guide plate 54 is used to scatter light generated from the U-type lamp 56 and straight lamp 92 to the optical layer 62. The optical layer 62 is used to fog and concentrate the light from the light guide plate 54 in order to provide more uniform light and wide front view angle for the display panel 52. As shown in FIG. 12, the lamp fixing support 64 wrapping the curved part and some straight part of the U-type lamp 56 and two ends of the straight lamp 92 is then assembled with the lampshade 58, the U-type lamp 56 and straight lamp 92 can provide uniform light from one side of the light guide plate 54, while the lampshade 58 and the reflecting sheet 60 are used to reflect the light generated by the U-type lamp 56 and the straight lamp 92 back to the light guide plate 54 in order to increase the light utility rate and then provide a better output luminance. This preferred embodiment introduces an U-type lamp 56 with a straight lamp 92 that can provide uniform light to the light guide plate 54 from one side thereof. The emitting area formed by the U-type lamp and the straight lamp is the same as that formed by three straight lamps, but the number of the electrodes and the connection points of the conduction wires of the U-type and straight lamp are less than the number of those by using three straight lamps. The heat generated by the electrodes and the power consumption are both less then that by using three straight lamps. That is to say, the light source of the edge-type backlight module 90 can apply the U-type lamp 56 of the present invention in association with the conventional straight lamp 92, and this depends on the design requirement.

To sum up, the main spirit of the present invention is by using the lamp with curved shape to act as the light source of the edge-type backlight module; therefore one can reduce the whole number of the electrodes of the lamps and the connecting points of the conducting wire efficiently, lower the heat generated and the power consumed by the electrodes, and then lower the wiring complexity of the conducting wires efficiently. Therefore there are ways of disposing various U-type lamps, such as disposing different numbers of different U-type lamps, disposing all the openings of the U-type lamps into the same lamp fixing support then disposing all the curved ends in another lamp fixing support is also workable, adopting various U-type lamps with different quantity in combination with straight lamp to act as light source, even more by adopting other lamps with different shapes like S-type lamp to act as light source are all includes in the claims of the present invention.

Compare to the conventional edge-type backlight module, the present invention uses the curve-shaped lamp to replace the conventional straight lamp for acting as the light source of the edge-type backlight module, and then reducing the number of the electrodes of the lamps and the connection points with the conducting wire efficiently, and then lowering the heat generated by all the electrodes such that the lamps can operate in a more efficient working temperature and the emitting efficiency is higher accordingly. Besides, the simple wiring method can reduce the possibility of the instable quality owing to the complex wiring arrangement more efficiently. Moreover, the staggered U-type lamps can reduce the phenomenon of the chromatic aberration at two ends of the lamp because of the process of siphoning fluorescent powder, and the display panel gets more uniform hues distribution. In addition, since the high voltage electrodes of the U-type lamp are disposed at two sides of the edge-type backlight module, this can avoid the concentration of heat sources. Therefore the temperature of the backlight module is reduced efficiently, while the efficiency of the lump is increased, and then the display quality gets improved.

Those skilled in the art will readily observe that numerous modifications and alterations of the device and method may be made while retaining the teachings of the invention. Accordingly, the above disclosure should be construed as limited only by the metes and bounds of the appended claims.

1. An edge-type backlight module, including:
a light guide plate;
a lampshade disposed on a lateral side of the light guide plate; and
at least one lamp with at least one curved part being disposed inside the lampshade for emitting light to the lateral side of the light guide plate.

2. The edge-type backlight module according to claim 1, further comprising two lamp fixing supports disposed at two ends of the lamp.

3. The edge-type backlight module according to claim 2, wherein the lamp has two openings being disposed inside the same lamp fixing support.

4. The edge-type backlight module according to claim 2, wherein the lamp has two openings being disposed inside the lamp fixing support.

5. The edge-type backlight module according to claim 2, wherein the curved part of the lamp is hidden inside the lamp fixing supports.

6. The edge-type backlight module according to claim 1, further comprising a reflecting sheet disposed below the light guide plate and the lamp for reflecting the light emitted down through the light guide plate back to the light guide plate.

7. The edge-type backlight module according to claim 1, wherein the lamp is a cold cathode fluorescent lamp.

8. The edge-type backlight module according to claim 1, wherein the lamp is a U-type lamp.

9. The edge-type backlight module according to claim 1, wherein the lamp is a S-type lamp.

10. The edge-type backlight module according to claim 1, wherein two openings of the lamp are electrically connected to two high voltage electrodes.

11. The edge-type backlight module according to claim 10, further comprising a inverter electrically connected to two high voltage electrodes of the lamp for transferring the electrical power into the working voltage of the lamp.

12. The edge-type backlight module according to claim 1, further comprising a straight lamp disposed between two arms of the lamp.

13. The edge-type backlight module according to claim 1, further comprising two lamp fixing supports disposed at two ends of the lamp, openings of the two adjacent lamps being disposed in two different lamp fixing supports.

14. The edge-type backlight module according to claim 1, wherein the two adjacent lamp arms are staggered.

15. The edge-type backlight module according to claim 1, wherein the two adjacent lamp arms are oblique staggered.
